(19) United States
(12) Patent Application Publication
(10) Pub. No.: US 2024/0416749 A1
(43) Pub. Date: Dec. 19, 2024

(54) Human-Computer Interaction Method and System for Vehicle

(71) Applicant: Illinois Tool Works Inc., Glenview, IL (US)

(72) Inventors: Wenquan SHA, Shanghai (CN); Kangxi NING, Shanghai (CN); Hongpeng ZHONG, Shanghai (CN)

(21) Appl. No.: 18/734,586

(22) Filed: Jun. 5, 2024

(30) Foreign Application Priority Data
Jun. 13, 2023 (CN) 202310699497.X

(51) Int. Cl. B60K 35/10; G01H 17/00

(52) U.S. Cl. CPC B60K 35/10; G01H 17/00

(57) ABSTRACT

The present disclosure relates to a human-computer interaction method for a vehicle. The vehicle is provided with a controller and a body of the vehicle is provided with a number of operating regions. The method includes: setting a linkage operation relationship between the number of operating regions; disposing a number of actuators for the number of operating regions, each of the number of operating regions including one corresponding actuator; disposing a plurality of vibration sensors for the number of operating regions, at least one vibration sensor being disposed on each of the number of operating regions; and monitoring a tapping signal on a corresponding one of the number of operating regions by the at least one vibration sensor, where the controller is configured to control the number of actuators in the number of operating regions based on the linkage operation relationship and the tapping signal. The human-computer interaction method and system for a vehicle provided in the present disclosure improve the accuracy of control over vehicle components while reducing the costs of the vehicle.

### RELATED APPLICATIONS

The present application claims the benefit of Chinese Patent Application No. 202310699497.X, filed Jun. 13, 2023, titled “Human-Computer Interaction Method and System for Vehicle,” the contents of which are hereby incorporated by reference.

### TECHNICAL FIELD

The present disclosure relates to the technical field of vehicle control, and more specifically, to a human-computer interaction method and system for a vehicle.

BACKGROUND

With the development of society, more and more people choose vehicles as their means of transportation. When driving vehicles, people need to interact with the vehicles to control various functions of the vehicles. Therefore, a human-computer interaction method and system for a vehicle are needed to facilitate the interaction between a person and a vehicle.

### SUMMARY

The present disclosure relates generally to a human-computer interaction system and method for a vehicle, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1 is a structural schematic diagram 100 of a vehicle having a controller and a plurality of vibration sensors according to an embodiment of the present disclosure.

FIG. 2 is a structural schematic diagram 200 of connection of a plurality of vibration sensors, a plurality of actuators, and a controller according to an embodiment of the present disclosure.

FIG. 3 is a flowchart 300 of a human-computer interaction method for a vehicle according to an embodiment of the present disclosure.

FIG. 4A and FIG. 4B are a schematic diagram 400 of a positional relationship between tapping points and a plurality of vibration sensors according to an embodiment of the present disclosure.

FIG. 5 is a structural schematic diagram 500 of functional units of a human-computer interaction system for a vehicle according to an embodiment of the present disclosure.

FIG. 6 is a structural schematic diagram 600 of internal functions of a controller shown in FIG. 5.

FIG. 7 is a structural schematic diagram 700 of internal functions of a vibration sensor according to an embodiment of the present disclosure.

FIG. 8 is a schematic diagram 800 of a positional relationship between a vehicle body component and its surrounding effective tapping region according to an embodiment of the present disclosure.

FIG. 9 is a logical schematic diagram 900 of an anti-false triggering function according to an embodiment of the present disclosure.

FIG. 10 is an example diagram 1000 of a linkage operation relationship table between a number of operating regions on a vehicle according to an embodiment of the present disclosure.

### DETAILED DESCRIPTION OF EMBODIMENTS

Various specific embodiments of the present disclosure will be described below with reference to the accompanying drawings which constitute part of the present disclosure, but would not limit the scope of the present disclosure. It should be understood that although the terms such as “front”, “rear”, “upper”, “lower”, “left”, “right” and so on indicating directions are used in the present disclosure to describe orientations of various illustrative structural parts and elements in the present disclosure, the terms used herein are merely used for ease of description and are determined based on the illustrative orientation shown in the accompanying drawings. Since the embodiments disclosed in the present disclosure can be provided in different orientations, the terms indicating directions are merely illustrative and should not be considered as limitations. In addition, the terms “first”, “second”, etc. used in the present disclosure are merely used to distinguish different objects, instead of indicating that there is any particular sequential relationship between these objects. The term “comprise/include” and derivatives thereof mean inclusion without limitation. Unless otherwise specified and limited, the terms “mounting”, “connecting” and “connection” should be understood broadly. For example, they may be mechanical or electrical connection, internal communication between two elements, or direct connection or indirect connection via an intermediate medium. For those of ordinary skills in the art, the specific meanings of the above terms can be understood according to specific cases. If possible, the same or similar reference signs used in the present disclosure refer to the same components.

Currently, people mainly control different functions of vehicles in the following ways: (1) controlling some specific functions of the vehicles through vehicle remote control keys; (2) controlling the vehicles through control buttons provided outside and inside of the vehicle; (3) sending instructions to the vehicles through voice control systems of the vehicles to implement various functions of the vehicles; and (4) controlling the functions of the vehicles by acquiring gestures of drivers by using cameras provided on the vehicles. With the rapid development of electric vehicles, especially smart electric vehicles, people hope to interact with the vehicles in a more convenient way to control the vehicles.

According to the first aspect of the present disclosure, a human-computer interaction method for a vehicle is provided. The vehicle is provided with a controller and a body of the vehicle is provided with a number of operating regions. The method includes: setting a linkage operation relationship among the number of operating regions; disposing a number of actuators for the number of operating regions, each of the number of operating regions including one corresponding actuator; disposing a plurality of vibration sensors for the number of operating regions, at least one vibration sensor being disposed on each of the number of operating regions; and monitoring a tapping signal on a corresponding one of the number of operating regions by the at least one vibration sensor, where the controller is configured to control the number of actuators in the number of operating regions based on the linkage operation relationship and the tapping signal.

According to the first aspect of the present disclosure, the controller is configured to perform the following operations: (i) receiving a monitored tapping signal; (ii) identifying a tapped operating region associated with the tapping signal; (iii) activating an actuator in the tapped operating region; and (iv) activating actuators in other operating regions associated with the tapped operating region based on the linkage operation relationship.

According to the first aspect of the present disclosure, the linkage operation relationship is defined by a quantity of tapping signals, where one tap on each of the number of operating regions generates one tapping signal.

According to the first aspect of the present disclosure, the controller is configured to: after the first tapping signal is received, monitor a next tapping signal within a preset time window, and activate the number of actuators based on a quantity of received tapping signals after the time window ends.

According to the first aspect of the present disclosure, each of the plurality of vibration sensors includes a vibration sensor identification unit configured to store a sensor identifier representing a region location of the vibration sensor.

According to the first aspect of the present disclosure, the method includes: disposing a number of regional vibration sensors for an operating region of the number of operating regions, the number of regional vibration sensors having the same vibration sensor identifier, where the controller is configured to perform the following operations when a tapping signal monitored by each of the number of regional vibration sensors is received: (i) activating an actuator in the operating region; and (ii) activating actuators in other operating regions associated with the operating region based on the linkage operation relationship.

According to the first aspect of the present disclosure, the method includes: setting a linkage operation relationship table, where the linkage operation relationship table indicates the linkage operation relationship, the linkage operation relationship table is used to represent the linkage operation relationship among the number of operating regions, and the linkage operation relationship table is stored in a memory of the controller.

According to the first aspect of the present disclosure, the number of actuators include at least one of the following: a vehicle door open/close actuator, a concealed door handle open/close actuator, a window open/close actuator, a charging port cover open/close actuator, a sunroof open/close actuator, an engine hood open/close actuator, a filler cap open/close actuator, a trunk open/close actuator, a rear-view mirror unfold/fold actuator, and a lighting on/off actuator.

According to the first aspect of the present disclosure, the vehicle door open/close actuator includes at least one of the following: a left-front door open/close actuator, a right-front door open/close actuator, a left-rear door open/close actuator, and a right-rear door open/close actuator.

According to the first aspect of the present disclosure, the rear-view mirror unfold/fold actuator includes at least one of the following: a left exterior rear-view mirror unfold/fold actuator, a right exterior rear-view mirror unfold/fold actuator, and a central interior rear-view mirror unfold/fold actuator.

According to the first aspect of the present disclosure, the method further includes: using one or more gesture signal sensors to monitor gesture signals on the number of operating regions, and after the gesture signals are monitored, activating the number of vibration sensors to monitor tapping signals on the number of operating regions.

According to another aspect of the present disclosure, a human-computer interaction system for a vehicle is provided. A body of the vehicle is provided with a number of operating regions. The system includes: a number of vibration sensors disposed in the number of operating regions, at least one of the plurality of vibration sensors is provided on each of the number of operating regions, and each of the plurality of vibration sensors being configured to monitor a tap on a corresponding operating region to generate a tapping signal; a number of actuators, each of the number of operating regions including one corresponding actuator; a linkage operation relationship apparatus defining a linkage operation relationship among the number of operating regions; and a controller including a processing unit, the processing unit being configured to: control the number of actuators in the number of operating regions based on the linkage operation relationship apparatus and the tapping signal.

According to another aspect of the present disclosure, the processing unit is configured to perform the following operations: (i) receiving a monitored tapping signal; (ii) identifying a tapped operating region associated with the tapping signal; (iii) activating an actuator in the tapped operating region; and (iv) activating actuators in other operating regions associated with the tapped operating region based on the linkage operation relationship apparatus.

According to another aspect of the present disclosure, the controller further includes a memory, the linkage operation relationship apparatus includes a linkage operation relationship table, and the linkage operation relationship table is stored in the memory.

According to another aspect of the present disclosure, a linkage operation relationship in the linkage operation relationship table is defined by a tapping signal, where one tap on each of the number of operating regions generates one tapping signal.

According to another aspect of the present disclosure, the controller is configured to: after the first tapping signal is received, monitor a next tapping signal within a preset time window, and activate the number of actuators based on a quantity of received tapping signals after the time window ends.

According to another aspect of the present disclosure, each of the plurality of vibration sensors includes a vibration sensor identification apparatus configured to store a sensor identifier representing a region location of the vibration sensor.

According to another aspect of the present disclosure, a number of regional vibration sensors are disposed for an operating region of the number of operating regions, and the number of regional vibration sensors have the same vibration sensor identifier, where the controller is configured to perform the following operations when a tapping signal monitored by each of the number of regional vibration sensors is received: (i) activating an actuator in the operating region; and (ii) activating actuators in other operating regions associated with the operating region based on the linkage operation relationship table.

According to another aspect of the present disclosure, the controller includes: an input interface configured to receive tapping signals from the plurality of vibration sensors; a processing unit configured to process the tapping signals and generate a driving signal; an output interface configured to transmit the generated driving signal to the number of actuators; a memory configured to store an executable program and a linkage operation relationship table, where the processing unit generates the driving signal based on the executable program and the linkage operation relationship table, and the linkage operation relationship table is used to represent the linkage operation relationship among the number of operating regions; and a bus, where the processing unit, the input interface, the output interface, and the memory are connected to the bus.

According to another aspect of the present disclosure, the number of actuators include at least one of the following: a vehicle door open/close actuator, a concealed door handle open/close actuator, a window open/close actuator, a charging port cover open/close actuator, a sunroof open/close actuator, an engine hood open/close actuator, a filler cap open/close actuator, a trunk open/close actuator, a rear-view mirror unfold/fold actuator, and a lighting on/off actuator.

According to another aspect of the present disclosure, the vehicle door open/close actuator includes at least one of the following: a left-front door open/close actuator, a right-front door open/close actuator, a left-rear door open/close actuator, and a right-rear door open/close actuator.

According to another aspect of the present disclosure, the rear-view mirror unfold/fold actuator includes at least one of the following: a left exterior rear-view mirror unfold/fold actuator, a right exterior rear-view mirror unfold/fold actuator, and a central interior rear-view mirror unfold/fold actuator.

Some of the additional aspects and advantages of the present disclosure will be set forth in the following description, and some will become apparent from the following description, or be learned by practice of the present disclosure.

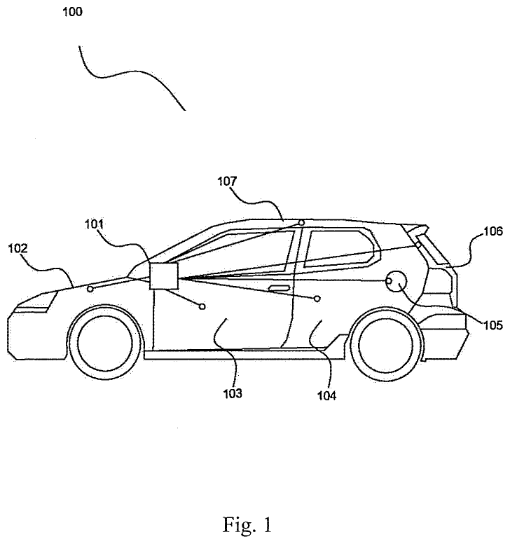

FIG. 1 is a structural schematic diagram 100 of a vehicle having a controller and a plurality of vibration sensors according to an embodiment of the present disclosure.

As shown in FIG. 1, according to an embodiment of the present disclosure, a plurality of vibration sensors is respectively arranged on different vehicle body components of a vehicle. For example, vibration sensors are respectively arranged on a front engine hood 102, a left-front door 103, a left-rear door 104, a fuel filler cap/charging port cover 105, a trunk door 106, and a sunroof cover 107 of the vehicle. These vibration sensors are connected to the same controller 101 located on the vehicle. The plurality of vibration sensors are respectively configured to monitor vibration (tapping) signals on the respective vehicle body components, and transmit the monitored vibration signals to the controller 101.

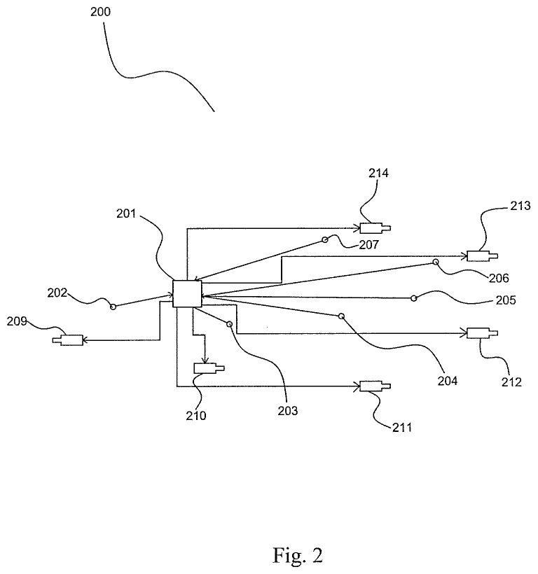

FIG. 2 is a structural schematic diagram 200 of connection of a plurality of vibration sensors, a plurality of actuators, and a controller according to an embodiment of the present disclosure.

As shown in FIG. 2, according to an embodiment of the present disclosure, a plurality of vibration sensors 202, 203, 204, 205, 206, and 207 disposed on different vehicle body components of the vehicle are respectively connected to a controller 201, and send vibration signals detected on the vehicle body components to the controller 201. In addition, a plurality of actuators 209, 210, 211, 212, 213, and 214 are respectively arranged on different vehicle body components for driving different vehicle body components. For example, the actuator 209 is configured to open/close the front engine hood, the actuator 210 is configured to open/close the left-front door, the actuator 211 is configured to open/close the left-rear door, the actuator 212 is configured to open/close the fuel filler cap/charging port cover, the actuator 213 is configured to open/close the trunk door, and the actuator 214 is configured to open/close the sunroof. These actuators receive control signals from the controller 201 respectively, and drive different vehicle body components based on the received control signals respectively.

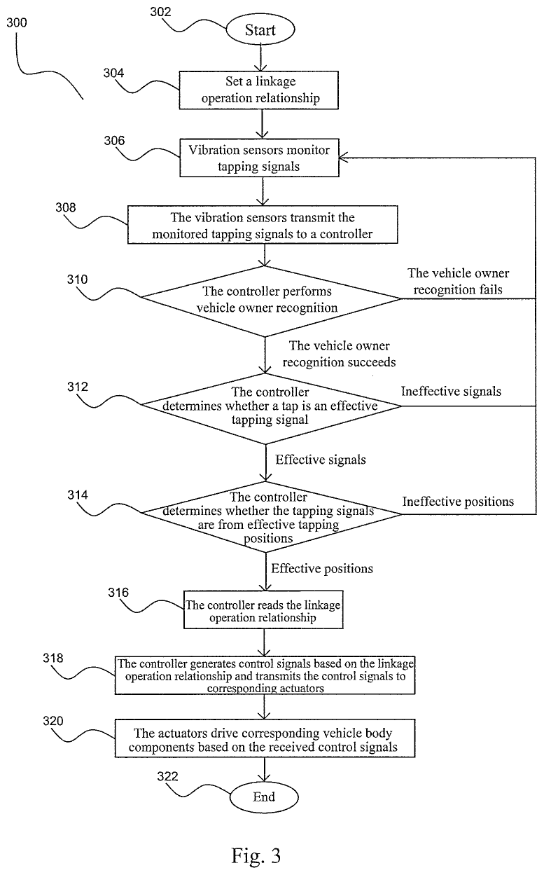

FIG. 3 is a flowchart 300 of a human-computer interaction method for a vehicle according to an embodiment of the present disclosure.

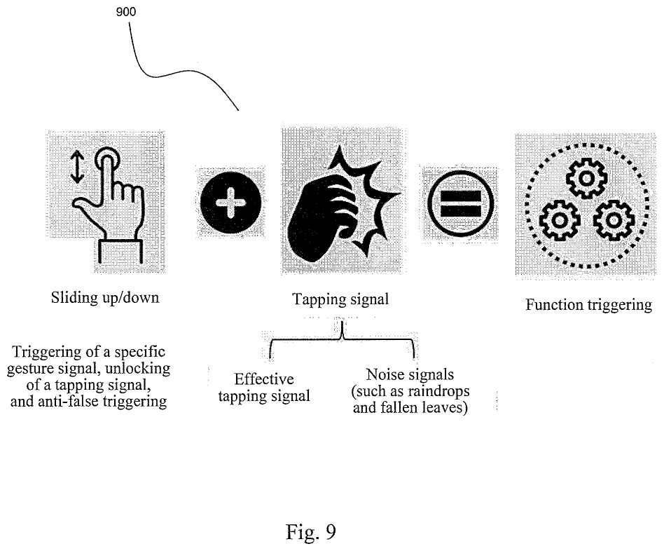

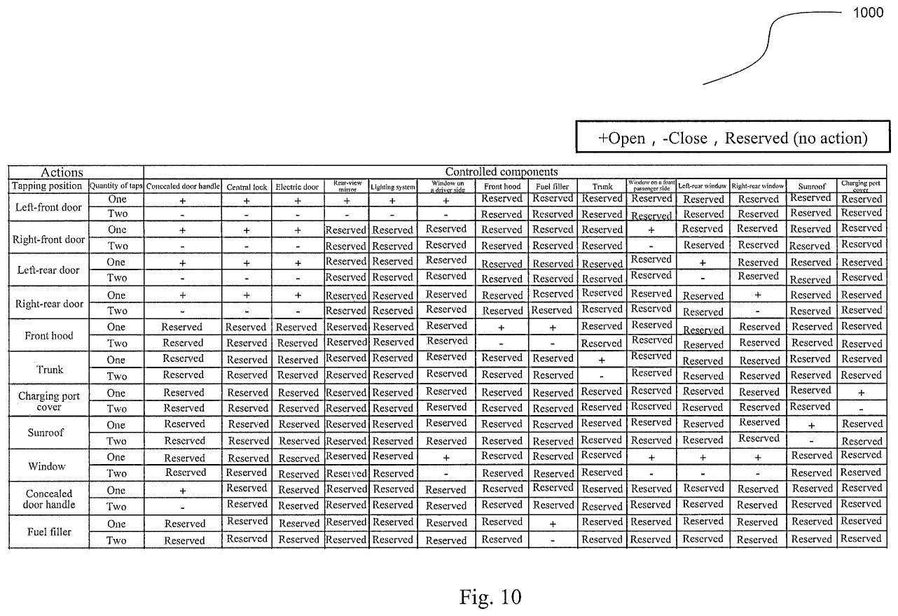

As shown in FIG. 3, according to an embodiment of the present disclosure, the human-computer interaction method for a vehicle starts from step 302. At step 304, a linkage operation relationship is set for different operating regions on a vehicle body of the vehicle, where the linkage operation relationship defines whether different operating regions on the vehicle body of the vehicle are linked based on control signals. The linkage operation relationship will be described in detail in FIG. 10 below. At step 306 below, a plurality of vibration sensors arranged on the vehicle body of the vehicle monitor tapping signals on the vehicle body components. When a user taps on a vehicle body component, a tap action causes the vehicle body component to vibrate, and the vibration sensors arranged on the vehicle body components can detect the vibration. At step 308, the vibration sensors transmit the monitored tapping signals to the controller. At step 310, after receiving the tapping signals sent by the vibration sensors, the controller performs identity recognition on the user to determine whether the user performing the tap action is a vehicle owner. As an embodiment, when the user carries a vehicle key and is within a predetermined distance range from the vehicle, a signal receiver in the vehicle can receive a signal transmitted by the vehicle key, in which case the controller can determine that the user performing the tap action is the vehicle owner of the vehicle. Those skilled in the art should appreciate that an identity of a vehicle owner may also be recognized in other ways. If the vehicle owner recognition fails, the process returns from step 310 to step 306 at which the plurality of vibration sensors continue to monitor tapping signals on the vehicle body components; and if the vehicle owner recognition succeeds, the process proceeds to step 312. At step 312, the controller determines whether the tapping signals are effective tapping signals. As an embodiment, the controller filters and amplifies the tapping signals, removes ineffective tapping signals (such as tapping signals from vibrations caused by objects such as leaves falling on the vehicle body), and calculates a quantity of effective taps within a predetermined time period. If it is determined that the tapping signals are ineffective tapping signals, the process returns to step 306 from step 312, and the plurality of vibration sensors continue to monitor tapping signals on the vehicle body components. If it is determined that the tapping signals are effective tapping signals, the process proceeds to step 314. At step 314, the controller determines whether the tapping signals are from effective tapping positions. As an embodiment, a plurality of vibration sensors is arranged on the left-front door of the vehicle. When the left-front door is tapped, the plurality of vibration sensors on the left-front door can monitor the tapping signals and send the detected tapping signals to the controller. In this case, the controller calculates a specific position of a tapping point on the left-front door based on a time when the tapping signal reaches different vibration sensors (that is, the time when the controller receives the tapping signals from different vibration sensors). Those skilled in the art should appreciate that a specific position of the tapping point may also be calculated in other ways. If the calculated position of the tapping point is beyond an effective tapping range of the vehicle body components, it is determined that the tapping signals are generated at an ineffective position, and the process returns from step 314 to step 306 at which the plurality of vibration sensors continue to monitor tapping signals on the vehicle body components. If the calculated position of the tapping point is within the effective tapping range of the vehicle body components, it is determined that the tapping signals are generated at the effective position, and the method proceeds to step 316. At step 316, the controller reads the linkage operation relationship (to be described in FIG. 9). At step 317, the controller generates control signals based on the read linkage operation relationship according to a quantity of tapping signals determined at step 312 above and generation positions of the tapping signals determined at step 314, and sends the generated control signals to the corresponding actuators located on different components of the vehicle (to be described in FIG. 9). At step 320, the actuators drive the corresponding vehicle body components based on the received control signals. Then, the process ends at step 322. Those skilled in the art should appreciate that steps of the above human-computer interaction method for a vehicle can be increased or reduced according to design requirements, as long as the specific functions can be implemented.

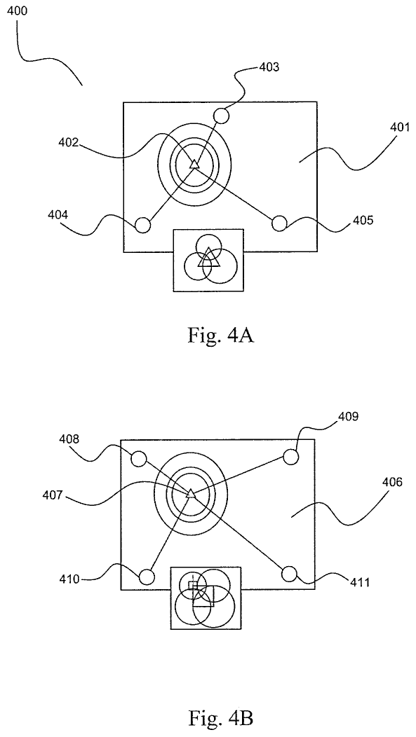

FIG. 4A and FIG. 4B are a schematic diagram 400 of a positional relationship between tapping points and a plurality of vibration sensors according to an embodiment of the present disclosure.

As shown in FIG. 4A, according to an embodiment of the present disclosure, three vibration sensors 403, 404, and 405 may be arranged on a vehicle body component 401 to monitor tapping signals on the vehicle body component and calculate a specific position of a tapping point 402. When a user of the vehicle taps the vehicle body component, a position of the tapping point 402 is shown in FIG. 4A, in which case a vibration signal generated by the tapping will propagate outward with the tapping point 402 as a center. Since distances between the three vibration sensors and the tapping point 402 are different, a vibration signal reaches the vibration sensor 403 after a time period t1, reaches the vibration sensor 404 after a time period t2, and reaches the vibration sensor 405 after a time period t3. It is assumed that a propagation speed v of a vibration signal on a vehicle body component is constant, and then the specific position of the tapping point may be calculated based on time periods when the vibration signals reach the three vibration sensors. Specifically, first, based on the propagation speed v of the vibration signal and a time period t1 when signal reaches the sensor 403, it may be determined, through calculation, that the tapping point should be located at a specific point on the circumference of a circle with the vibration sensor 403 as a center and with a radius v*t1. Then, the same method may be used to determine, through calculation, that the tapping point should also be located at a specific point on the circumference of a circle with the vibration sensor 404 as a center and with a radius v*t2, and at a specific point on the circumference of a circle with the vibration sensor 405 as a center and with a radius v*t3.Finally, it may be determined that an actual position of the tapping point should be within an enclosed region where the circumferences of the three circles intersect.

As shown in FIG. 4B, according to another embodiment of the present disclosure, four vibration sensors 408, 409, 410, and 411 may be arranged on a vehicle body component 406 to monitor tapping signals on the vehicle body component and calculate a specific position of a tapping point 407 using a method similar to that described in FIG. 4A. As can be seen in FIG. 4B, the more vibration sensors are arranged on the vehicle body component, the smaller the enclosed region where circumferences of a number of circles intersect together will be, and thus the more accurate the calculated specific position of the tapping point will be. Those skilled in the art should understand that a corresponding quantity of vibration sensors may be arranged on the vehicle body components according to actual accuracy requirements and cost considerations.

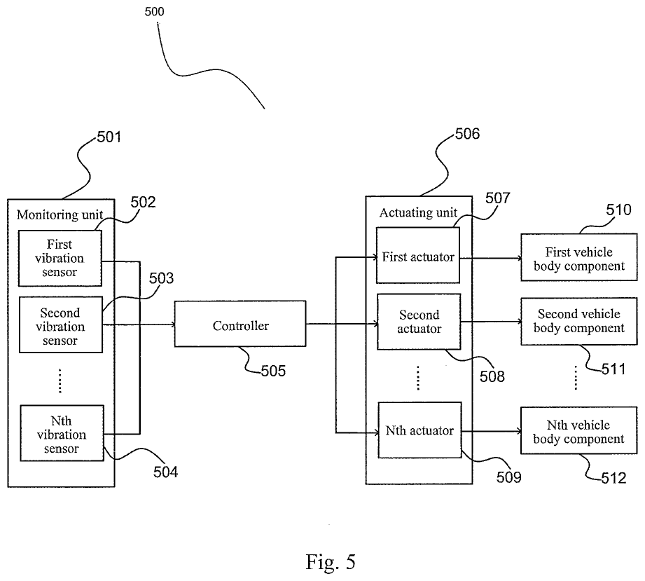

FIG. 5 is a structural schematic diagram 500 of functional units of a human-computer interaction system for a vehicle according to an embodiment of the present disclosure.

As shown in FIG. 5, according to another embodiment of the present disclosure, a human-computer interaction system 500 for a vehicle of the present disclosure includes a monitoring unit 501, a controller 505, an actuating unit 506, and vehicle body components. The monitoring unit 501 includes a number of vibration sensors 502-504, the actuating unit 506 includes a number of actuators 507-509, and the vehicle body components include a number of vehicle body components 510-512 (for example, the front engine hood 102, the left-front door 103, the left-rear door 104, the fuel filler cap/charging port cover 105, the trunk door 106, and the sunroof cover 107 of the vehicle shown in FIG. 1). The number of vibration sensors 502-504 are arranged on different vehicle body components to monitor tapping signals on the vehicle body components. After monitoring the tapping signals on the vehicle body components, the corresponding vibration sensors arranged thereon transmit the tapping signals to the controller 505. The controller 505 processes (for example, steps 310 to 318 in FIG. 3) the received tapping signals, generates control signals, and transmits the control signals to one or more corresponding actuators of the number of actuators 507-509. The actuators 507-509 are connected to the corresponding vehicle body components 501-512, respectively. The actuators receiving the control signals drive the vehicle body components to which the actuators are connected to perform, for example, opening/closing actions.

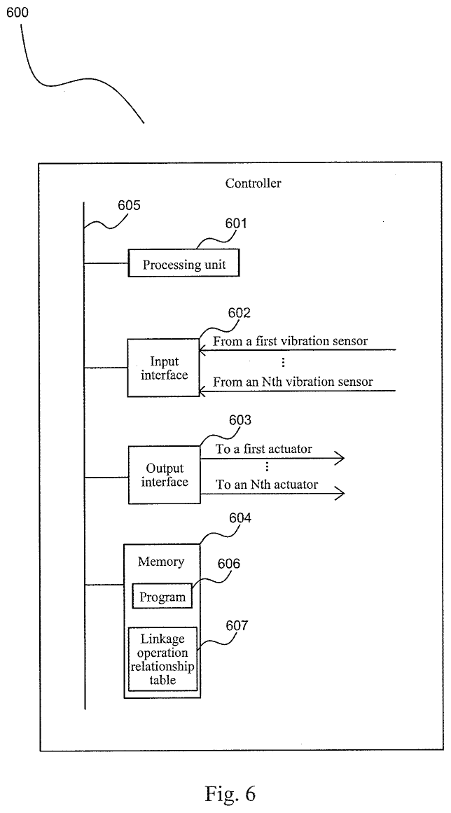

FIG. 6 is a structural schematic diagram 600 of internal functions of a controller shown in FIG. 5.

As shown in FIG. 6, according to an embodiment of the present disclosure, the controller includes a processing unit 601, an input interface 602, an output interface 603, a memory 604, and a bus 605. The processing unit 601, the input interface 602, the output interface 603, and the memory 604 are communicatively connected to each other through a bus 605. The processing unit may read data from the input interface 602 and the memory 604 through the bus 605, and send data to the output interface 603. The memory 604 stores an executable program 606 and a linkage operation relationship table 607. The program 606 includes program code for processing a tapping signal, such as program code for filtering and amplifying the tapping signal and program code for calculating a specific position of a tapping point. Those skilled in the art should understand that the program 606 may further include other program code for processing the tapping signal. The linkage operation relationship table 607 defines a linkage operation relationship between different vehicle body components, such as a linkage operation relationship between a concealed door handle and a rear-view mirror, that is, the rear-view mirror is unfolded while the concealed door handle is extended. The linkage operation relationship table 607 will be described in more detail in FIG. 10 below. As shown in FIG. 6, the input interface 602 receives tapping signals from a number of vibration sensors, and the processing unit 601 reads, through the bus 605, the tapping signals received by the input interface 602. After receiving the tapping signals, the processing unit 601 reads the program 606 from the memory through the bus 605 to process the tapping signals, and then the processing unit 601 reads the linkage operation relationship table 607 and generates control signals based on the processed signals and the linkage relationship in the linkage operation relationship table. Finally, the processing unit sends the generated control signals to related actuators through the output interface 603.

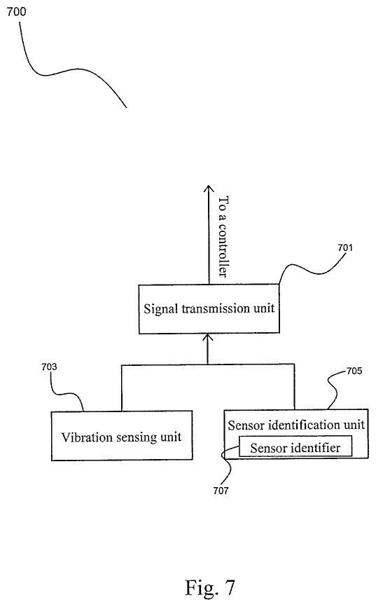

FIG. 7 is a structural schematic diagram 700 of internal functions of a vibration sensor according to an embodiment of the present disclosure.

As shown in FIG. 7, according to an embodiment of the present disclosure, the vibration sensor includes a signal transmission unit 701 for transmitting a signal, a vibration sensing unit 703 for monitoring a tapping signal, and a sensor identification unit 705 for indicating a position of the vibration sensor. The sensor identification unit 705 stores a sensor identifier 707 indicating a position of a region where the sensor is located. After monitoring a tapping signal, the vibration sensing unit 703 transmits the tapping signal to the controller (not shown) through the signal transmission unit 701. The sensor identification unit 705 transmits the sensor identifier 707 stored therein to a controller (not shown) through the signal transmission unit 701. The controller may obtain, based on the received sensor identifier 707, information about a position of a region where the sensor that sends the tapping signal is located. As an embodiment, the vibration monitoring sensor may be an electric sensor, a piezoelectric sensor, an eddy current sensor, an inductive sensor, a capacitive sensor, a resistive sensor, an electromagnetic sensor, etc. The piezoelectric sensor may be a piezoelectric ceramic sensor (commonly used piezoelectric ceramic materials include a lead zirconate titanate piezoelectric ceramics (PZT) material and a non-lead piezoelectric ceramics (such as BaTiO3) material), a piezoelectric film sensor (a polymer piezoelectric material sensor, such as a polyvinylidene difluoride PVF2 sensor and a polyvinyl fluoride PVF sensor), a piezoelectric crystal sensor, or another sensor with piezoelectric effect.

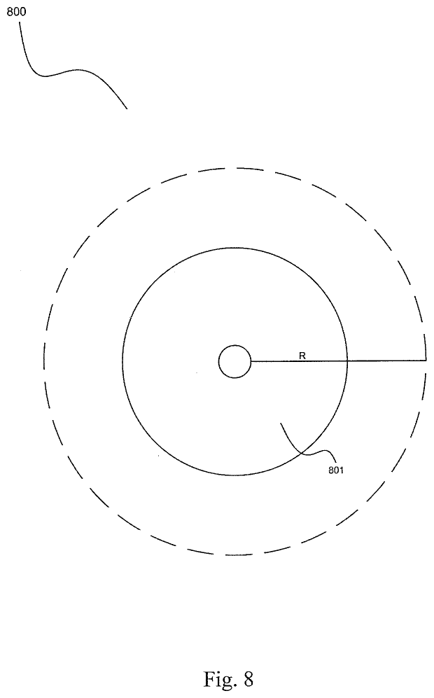

FIG. 8 is a schematic diagram 800 of a positional relationship between a vehicle body component and its surrounding effective tapping region according to an embodiment of the present disclosure.

As shown in FIG. 8, as an embodiment, a circular region (the dashed line region in FIG. 8) with a radius R is drawn with a center origin of a vehicle body component 801 (for example, a charging port cover) as a center. When the calculated position of the tapping signal is located on the vehicle body component 801 or in the circular region, the controller determines that the tapping signal is at an effective tapping position and can perform subsequent processing on the tapping signal. If the calculated position of the tapping signal is outside the circular region, the controller determines that the tapping signal is not from an effective tapping position, and the tapping signal is an ineffective tapping signal.

FIG. 9 is a logical schematic diagram 900 of an anti-false triggering function according to an embodiment of the present disclosure.

As shown in FIG. 9, in order to prevent false triggering by a user, the present disclosure may further design an anti-false triggering function before the user taps the vehicle body component. As an embodiment, an additional sensor may be arranged on the vehicle body component to sense a specific gesture (for example, slide) of the user. A vibration sensor on the vehicle body component is in a non-activated state by default and does not monitor tap actions of the user in this case. The user first needs to perform a slide action (such as sliding up/down) at a specific position of the vehicle body component. The corresponding sensor detects the slide action of the user and then notifies the controller. The controller then activates a monitoring function of the vibration sensor, so that the vibration sensor starts to monitor a tap action of the user and filter out other noise signals (such as vibration signals caused by raindrops and fallen leaves falling on the vehicle body) to implement the corresponding control function. Those skilled in the art should understand that the anti-false triggering function may be implemented in other ways other than sliding the sensor.

FIG. 10 shows a linkage operation relationship table 1000 between a number of operating regions on a vehicle according to an embodiment of the present disclosure.

As shown in FIG. 10, the linkage operation relationship table 1000 defines a linkage operation relationship between a tap action and a controlled vehicle body component. In this table, the following tapping positions are listed as examples: a left-front door, a right-front door, a left-rear door, a right-rear door, a front hood, a trunk, a charging port cover, a sunroof, a window, a concealed door handle, and a fuel filler. The user may tap the above-mentioned vehicle regions with different quantities of taps (defined as 1 or 2 times in the diagram as an example), to control the vehicle body component of the vehicle. The following controlled components are also listed in the table as an example: a concealed door handle, a central control lock, an electric door, a rear-view mirror, a lighting system, a left-front window (window on a driver side), a front hood, a fuel filler, a trunk, a right-front window (window on a front passenger side), a left-rear window, a right-rear window, a sunroof, and a charging port cover. In addition, the “+” in the diagram indicates an opening action, “−” indicates a closing action, and “Reserved” indicates no action. The function is reserved for later addition. Those skilled in the art should understand that the above parameters in the diagram are merely exemplary, and different tapping positions, quantities of taps, controlled components, and actions may be defined based on an actual use environment. For example, although different quantities of taps are shown in the diagram 1000 to activate different operating actions, the quantities of taps can be deleted from the diagram according to actual requirements, so that an opening action is performed as long as a tapping signal is monitored (regardless of a quantity of taps). The following will describe a human-computer interaction process in detail based on three use scenarios, namely, a getting-on scenario, a getting-off scenario, and a region-based control scenario, in combination with the flowchart 300 of a human-computer interaction method for a vehicle in FIG. 3 and the linkage operation relationship table 1000 in FIG. 10.

As an embodiment, in the getting-on scenario, when a driver approaches the vehicle, the controller in the vehicle recognizes the identity of the driver by sensing the vehicle key or in other ways. The driver taps the left-front door once, and a vibration sensor arranged on the left-front door monitors a tapping signal and transmits the tapping signal and a sensor position identifier to the controller. The controller determines, based on whether the identity of the driver is successfully recognized, whether to process the received tapping signal. If the vehicle owner recognition fails, the processor does not process the received tapping signal, and the vibration sensor continues to monitor subsequent tapping signals. If the driver is successfully recognized as a vehicle owner, the controller will process, including filtering and amplifying, the received tapping signal to determine whether the tapping signal is an effective tapping signal. If it is determined that the tapping signal is an ineffective tapping signal, the controller does not perform subsequent processing, and the vibration sensor continues to monitor subsequent tapping signals. If it is determined that the tapping signal is an effective tapping signal, the controller calculates a specific position of the effective tapping signal based on the method described in FIG. 4A and FIG. 4B, and determines, based on the calculated specific position of the tapping point and the effective tapping region described in FIG. 8, whether the tapping signal is from an effective tapping position. If it is determined that the effective tapping signal is from an ineffective tapping position, the controller does not perform subsequent processing, and the vibration sensor continues to monitor subsequent tapping signals. If it is determined that the effective tapping signal is from an effective tapping position, the controller reads the linkage operation relationship table shown in FIG. 10, performs a corresponding search in the linkage operation relationship table based on a quantity of tapping signals (one) and a tapping position (left-front door) obtained in the previous step, and generates control signals. As can be seen in FIG. 10, when the tapping position is the left-front door and the quantity of taps is one, the concealed door handle, the central control lock, the electric door, the rear-view mirror, the lighting system, and the left-front window are linked and controlled to perform an opening operation. Therefore, the controller generates six control signals based on the linkage operation relationship in FIG. 10, and sends the control signals to six actuators for driving the concealed door handle, the central lock, the electric door, the rear-view mirror, the lighting system, and the left-front window. After receiving the control signals, the six actuators respectively control the concealed door handle, the central control lock, the electric door, the rear-view mirror, the lighting system, and the left-front window to perform the opening operation. At this point, the human-computer interaction process in the getting-on scenario is completed. As can be seen from the above, in the getting-on scenario, the driver can implement a series of “comfortable entry” functions such as extending the concealed door handle, unlocking the central control lock (or automatically opening the electric door), unfolding the rear-view mirror, turning on the welcome mode of the lighting system, lowering the window on the driver side, etc., by only tapping the left-front door on the driver side once. The driver does not need to operate a plurality of buttons to implement the above plurality of functions, which greatly simplifies operating steps of the driver, improves the efficiency of human-computer interaction and the comfort of entering the vehicle, and makes the interaction between the driver and the vehicle more in line with actual use habits.

Similarly, as an embodiment, in a getting-off scenario, the driver may control a series of functions such as retracting the concealed door handle, locking the central control lock (or automatically closing the electric door), folding the rear-view mirror, turning off the lighting system, raising the window on the driver side, etc. by continuously tapping (for example, twice) the left-front door within a preset time period. The controller waits for a preset time period after receiving the first tapping signal, and if the controller receives the second tapping signal within the preset time period, it is determined that the two tapping signals are continuous tapping signals. In other region-based control scenarios, for example, the driver may control the opening of the front hood and/or the opening of a cleaning fluid filler by tapping (for example, once) the front hood of the vehicle, control the opening of the trunk by tapping (for example, once) the trunk of the vehicle, and control the pop-up of the charging port cover by tapping the charging port cover of the vehicle. Those skilled in the art should understand that the above linkage operation relationship table is merely exemplary, and the control parameters therein can be edited and modified in a personalized manner according to customer requirements. The modified linkage operation relationship table is stored in the memory 604 of the controller of FIG. 6, so that a linkage control relationship between vehicle components is applicable to various vehicles and use scenarios. In addition, not limited to searching the linkage operation relationship table, those skilled in the art may also implement a linkage operation function by other methods of defining the linkage operation relationship (such as control code).

The human-computer interaction method and system for a vehicle of the present disclosure have the following advantages:

First, in the prior art, it is usually necessary to provide a plurality of controllers in a vehicle to control different actuators to implement different functions. According to the present disclosure, only one integrated controller is carried in the vehicle, and all actuators are controlled by the integrated controller, which greatly reduces the costs of the vehicle while improving the control efficiency.

Second, in the prior art, it is usually necessary that a driver uses different methods to control a single function of the vehicle. A linkage control method of the present disclosure is more convenient and intelligent, simplifies operating steps of the driver, improves the efficiency of human-computer interaction, and makes the interaction between the driver and the vehicle more in line with actual use habits.

Third, control parameters in a linkage operation relationship table in the present disclosure can be edited and modified in a personalized manner according to customer requirements, so that a linkage control relationship between vehicle components is applicable to various vehicles and use scenarios.

Although the present disclosure is described in conjunction with the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in the present disclosure are illustrative rather than restrictive. Therefore, the disclosed description in the present disclosure may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

What is claimed is:

1. A human-computer interaction method (300) for a vehicle, the vehicle being provided with a controller (101) and a body of the vehicle being provided with a number of operating regions (102-107), wherein the method comprises:
setting a linkage operation relationship between the number of operating regions (102-107);
disposing a number of actuators (209-214) for the number of operating regions (102-107), each of the number of operating regions (102-107) comprising one corresponding actuator (209-214);
disposing a plurality of vibration sensors (202-207) for the number of operating regions (102-107), at least one vibration sensor (202-207) being disposed on each of the number of operating regions (102-107); and
monitoring a tapping signal (302) on a corresponding one of the number of operating regions (102-107) by the at least one vibration sensor (202-207),
wherein the controller (101) is configured to control the number of actuators (209-214) in the number of operating regions (102-107) based on the linkage operation relationship and the tapping signal.

2. The method according to claim 1, wherein
the controller (101) is configured to perform the following operations: (i) receiving a monitored tapping signal; (ii) identifying a tapped operating region associated with the tapping signal; (iii) activating an actuator in the tapped operating region; and (iv) activating actuators in other operating regions associated with the tapped operating region based on the linkage operation relationship.

3. The method according to claim 1, wherein
the linkage operation relationship is defined by a quantity of tapping signals, wherein one tap on each of the number of operating regions (102-107) generates one tapping signal.

4. The method according to claim 3, wherein
the controller (101) is configured to: after the first tapping signal is received, monitor a next tapping signal within a preset time window, and activate the number of actuators based on a quantity of received tapping signals after the time window ends.

5. The method according to claim 1, wherein
each of the plurality of vibration sensors (202-207) comprises a vibration sensor identification unit (705) configured to store a sensor identifier (707) representing a region location of the vibration sensor.

6. The method according to claim 5, wherein the method further comprises:
disposing a number of regional vibration sensors for an operating region of the number of operating regions (102-107), the number of regional vibration sensors having the same vibration sensor identifier,
wherein the controller (101) is configured to perform the following operations when a tapping signal monitored by each of the number of regional vibration sensors is received: (i) activating an actuator in the operating region; and (ii) activating actuators in other operating regions associated with the operating region based on the linkage operation relationship.

7. The method according to claim 1, wherein the method further comprises:
setting a linkage operation relationship table (607), wherein the linkage operation relationship table (607) indicates the linkage operation relationship, the linkage operation relationship table (607) is used to represent the linkage operation relationship between the number of operating regions (102-107), and the linkage operation relationship table (607) is stored in a memory (604) of the controller (600).

8. The method according to claim 1, wherein
the number of actuators (209-214) comprise at least one of the following: a vehicle door open/close actuator, a concealed door handle open/close actuator, a window open/close actuator, a charging port cover open/close actuator, a sunroof open/close actuator, an engine hood open/close actuator, a filler cap open/close actuator, a trunk open/close actuator, a rear-view mirror unfold/fold actuator, and a lighting on/off actuator.

9. The method according to claim 8, wherein
the vehicle door open/close actuator comprises at least one of the following: a left-front door open/close actuator, a right-front door open/close actuator, a left-rear door open/close actuator, and a right-rear door open/close actuator.

10. The method according to claim 8, wherein
the rear-view mirror unfold/fold actuator comprises at least one of the following: a left exterior rear-view mirror unfold/fold actuator, a right exterior rear-view mirror unfold/fold actuator, and a central interior rear-view mirror unfold/fold actuator.

11. The method according to claim 1, wherein the method further comprises:
using one or more gesture signal sensors to monitor gesture signals on the number of operating regions (102-107), and after the gesture signals are monitored, activating the number of vibration sensors to monitor tapping signals on the number of operating regions (102-107).

12. A human-computer interaction system (500) for a vehicle, a body of the vehicle being provided with a number of operating regions (102-107), wherein the system comprises:
a number of vibration sensors (202-207) disposed in the number of operating regions (102-107), each of the number of operating regions (102-107) comprising at least one of the plurality of vibration sensors (202-207), and each of the plurality of vibration sensors (202-207) being configured to monitor a tap on a corresponding operating region (102-107) to generate a tapping signal;
a number of actuators (209-214), each of the number of operating regions (102-107) comprising one corresponding actuator (209-214);
a linkage operation relationship apparatus defining a linkage operation relationship between the number of operating regions (102-107); and
a controller (101) comprising a processing unit (601), the processing unit (601) being configured to: control the number of actuators (209-214) in the number of operating regions (102-107) based on the linkage operation relationship apparatus and the tapping signal.

13. The system according to claim 12, wherein
the processing unit (601) is configured to perform the following operations: (i) receiving a monitored tapping signal; (ii) identifying a tapped operating region associated with the tapping signal; (iii) activating an actuator in the tapped operating region; and (iv) activating actuators in other operating regions associated with the tapped operating region based on the linkage operation relationship apparatus.

14. The system according to claim 12, wherein
the controller (101) further comprises a memory (604), the linkage operation relationship apparatus comprises a linkage operation relationship table (607), and the linkage operation relationship table (607) is stored in the memory (604).

15. The system according to claim 14, wherein
a linkage operation relationship in the linkage operation relationship table (607) is defined by a tapping signal, wherein one tap on each of the number of operating regions (102-107) generates one tapping signal.

16. The system according to claim 15, wherein
the controller (101) is configured to: after the first tapping signal is received, monitor a next tapping signal within a preset time window, and activate the number of actuators based on a quantity of received tapping signals after the time window ends.

17. The system according to claim 12, wherein
each of the plurality of vibration sensors (202-207) comprises a vibration sensor identification unit (705) configured to store a sensor identifier (707) representing a region location of the vibration sensor.

18. The system according to claim 17, wherein
a number of regional vibration sensors are disposed for an operating region of the number of operating regions (102-107), and the number of regional vibration sensors have the same vibration sensor identifier,
wherein the controller (101) is configured to perform the following operations when a tapping signal monitored by each of the number of regional vibration sensors is received: (i) activating an actuator in the operating region; and (ii) activating actuators in other operating regions associated with the operating region based on the linkage operation relationship table.

19. The system according to claim 12, wherein the controller (600) comprises:
an input interface (602) configured to receive tapping signals from the plurality of vibration sensors (202-207);
a processing unit (601) configured to process the tapping signals and generate a driving signal;
an output interface (603) configured to transmit the generated driving signal to the number of actuators (209-214);
a memory (604) configured to store an executable program (606) and a linkage operation relationship table (607), wherein the processing unit (601) generates the driving signal based on the executable program (606) and the linkage operation relationship table (607), and the linkage operation relationship table (607) is used to represent the linkage operation relationship between the number of operating regions (102-107); and
a bus (605), wherein the processing unit (601), the input interface (602), the output interface (603), and the memory (604) are connected to the bus (605).

20. The system according to claim 12, wherein
the number of actuators (209-214) comprise at least one of the following: a vehicle door open/close actuator, a concealed door handle open/close actuator, a window open/close actuator, a charging port cover open/close actuator, a sunroof open/close actuator, an engine hood open/close actuator, a filler cap open/close actuator, a trunk open/close actuator, a rear-view mirror unfold/fold actuator, and a lighting on/off actuator.
